(19) United States
(12) Patent Application Publication
(10) Pub. No.: US 2020/0320168 A1
(43) Pub. Date: Oct. 8, 2020

(54) Discovering Customer Support Chat Sessions

(71) Applicant: Google LLC, Mountain View, CA (US)

(72) Inventors: Akhilesh Shirbhate, Sunnyvale, CA (US); Anup Goyal, Mountain View, CA (US)

(73) Assignee: Google LLC, Mountain View, CA (US)

(21) Appl. No.: 16/374,645

(22) Filed: Apr. 3, 2019

(51) Int. Cl. G06F 17/27; H04L 12/58

(52) U.S. Cl. CPC G06F 17/2705; G06F 17/2765; H04L 51/22

(57) ABSTRACT

A method includes receiving a plurality of chat conversations associated with a particular user and a plurality of different business entities. Each chat conversation of the plurality of chat conversations is between the user and a corresponding business entity of the plurality of different business entities. For each chat conversation of the plurality of chat conversations, the method also includes parsing the chat conversation for any keywords, harvesting metadata relevant to each parsed keyword, annotating the chat conversation with the metadata, indexing the annotated chat conversation, and storing the indexed, annotated chat conversation in a conversation data store. The method also includes receiving search criteria from a user device associated with the user, retrieving one or more of the indexed, annotated chat conversations that satisfy the received search criteria, and transmitting a search result to the user device.

### TECHNICAL FIELD

This disclosure relates to discovering customer chat sessions.

### BACKGROUND

Customers frequently use electronic communication such as email to communicate with customer support teams from businesses. These emails may be indexed by an email provider, stored in an email repository managed by the email provider, and searchable within the email repository through an email search interface. Customer Relationship Management (CRM) systems include software that enable customers to interact with an agent of a particular business through a social media platform. For instance, a social media platform can allow a user to interact with the business's profile, and, when the business's profile is integrated with CRM software, the business's customer support agents can directly respond to the customer. Customers also frequently contact businesses via online chat systems for customer support. The businesses use CRM software to manage their interactions with the customers. While businesses can view chat histories with their customers through their CRM software, the customers are unable to view a chat history once a session has ended.

### SUMMARY

One aspect of the disclosure provides a method for discovering customer support chat sessions. The method includes receiving, at data processing hardware, a plurality of chat conversations associated with a particular user and a plurality of different business entities, each chat conversation of the plurality of chat conversations between the user and a corresponding business entity of the plurality of different business entities. For each chat conversation of the plurality of chat conversations, the method includes parsing, by the data processing hardware, the chat conversation for any keywords and for each parsed keyword, harvesting, by the data processing hardware, metadata relevant to the keyword. The method also includes annotating, by the data processing hardware, the chat conversation with the metadata and indexing, by the data processing hardware, the annotated chat conversation. The method also includes storing, by the data processing hardware, the indexed, annotated chat conversation in a conversation data store in communication with the data processing hardware. The method also includes receiving, at the data processing hardware, search criteria from a user device associated with the user. The method also includes retrieving, by the data processing hardware, one or more of the indexed, annotated chat conversations that satisfy the received search criteria from the conversation data store and transmitting, by the data processing hardware, a search result to the user device. The search result includes the one or more indexed, annotated chat conversations retrieved from the conversation data store.

Implementations of the disclosure may include one or more of the following optional features. In some implementations, each chat conversation of the plurality of chat conversations includes at least one of text data or voice data. In some examples, harvesting the metadata relevant to the keyword includes obtaining the metadata from a source that is different than a source of the corresponding chat conversation. Optionally, the source of the metadata includes at least one of an email repository associated with the user, a calendar repository associated with the user, or a messaging repository associated with the user.

In some implementations, harvesting the metadata relevant to the keyword includes obtaining the metadata from at least one of a current chat conversation or one or more previous chat conversations associated with the user. In some examples, the method further includes executing, by the data processing hardware, a chat interface configured to pass chat posts, for each chat conversation of the plurality of chat conversations, between the user and a corresponding customer relationship management (CRM) system associated with the corresponding business entity of the plurality of different business entities.

The corresponding CRM systems associated with at least two of the plurality of different business entities may be different. The chat posts may include at least one of comments, messages, notes, remarks, questions, or replies published by the user and/or a respective agent of the corresponding business entity of the plurality of different business entities. Indexing the annotated chat conversation, in some implementations, includes indexing the annotated chat conversation based upon the corresponding business entity of the plurality of business entities. The search result, when received by the user device, may cause the user device to display the one or more indexed, annotated chat conversations retrieved from the conversation data store on a graphical user interface executing on the user device.

Another aspect of the disclosure provides a system for discovering customer support chat sessions. The system includes data processing hardware and memory hardware in communication with the data processing hardware. The memory hardware stores instructions that when executed on the data processing hardware cause the data processing hardware to perform operations. The operations include receiving a plurality of chat conversations associated with a particular user and a plurality of different business entities, each chat conversation of the plurality of chat conversations between the user and a corresponding business entity of the plurality of different business entities. For each chat conversation of the plurality of chat conversations, the operations include parsing the chat conversation for any keywords and for each parsed keyword, harvesting metadata relevant to the keyword. The operations also include annotating the chat conversation with the metadata and indexing the annotated chat conversation. The operations also include storing the indexed, annotated chat conversation in a conversation data store in communication with the data processing hardware. The operations also include receiving a search criteria from a user device associated with the user. The operations also include retrieving one or more of the indexed, annotated chat conversations that satisfy the received search criteria from the conversation data store and transmitting a search result to the user device. The search result includes the one or more indexed, annotated chat conversations retrieved from the conversation data store.

This aspect may include one or more of the following optional features. In some implementations, each chat conversation of the plurality of chat conversations includes at least one of text data or voice data. In some examples, harvesting the metadata relevant to the keyword includes obtaining the metadata from a source that is different than a source of the corresponding chat conversation. Optionally, the source of the metadata includes at least one of an email repository associated with the user, a calendar repository associated with the user, or a messaging repository associated with the user.

In some implementations, harvesting the metadata relevant to the keyword includes obtaining the metadata from at least one of a current chat conversation or one or more previous chat conversations associated with the user. In some examples, the operations further include executing a chat interface configured to pass chat posts, for each chat conversation of the plurality of chat conversations, between the user and a corresponding customer relationship management (CRM) system associated with the corresponding business entity of the plurality of different business entities.

The corresponding CRM systems associated with at least two of the plurality of different business entities may be different. The chat posts may include at least one of comments, messages, notes, remarks, questions, or replies published by the user and/or a respective agent of the corresponding business entity of the plurality of different business entities. Indexing the annotated chat conversation, in some implementations, includes indexing the annotated chat conversation based upon the corresponding business entity of the plurality of business entities. The search result, when received by the user device, may cause the user device to display the one or more indexed, annotated chat conversations retrieved from the conversation data store on a graphical user interface executing on the user device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for discovering user chat conversations.

FIG. 2 is a schematic view of a metadata data store of the system of FIG. 1.

FIG. 3A is a schematic view of an example search interface of the system of FIG. 1 receiving search criteria from a user device.

FIG. 3B is a schematic view of an example search interface of the system of FIG. 1 returning a search result to a user device.

FIG. 4 is a schematic view of an example policy controller of the system of FIG. 1.

FIG. 5 is a flowchart of an example method for discovering user chat sessions.

FIG. 6 is a schematic view of an example computing device that may be used to implement the systems and methods described herein.

Like reference symbols in the various drawings indicate like elements.

### DETAILED DESCRIPTION

Businesses often provide customer support platforms for customers to inquire about any issues or problems the customers may experience when using products and/or services provided by the businesses. These customer support platforms are increasingly switching to chat-based systems (e.g., instant messaging systems via an online portal) for facilitating chat sessions between the customers and agents representing these businesses. Here, a customer may contact a business's customer support by initiating a chat session through a specific proprietary software interface managed by the business and configured to communicate with a Customer Relationship Management (CRM) system associated the particular business for managing customer support interactions with customers. In this case, a history of the chat session is accessible to the business via CRM software executing on the CRM system, but unavailable to the customer once the chat session has ended. Thus, there is no easy way for customers to retrieve or discover a chat session after the chat session has ended.

Implementations herein are directed toward a centralized chat manager that manages chat conversations between user/customers and different business entities independent of the type of CRM system/software used by the business entities. Specifically, a particular user may be a customer of multiple different business entities and the centralized chat manager may execute a chat interface configured to facilitate chat conversations between the user and each of the different business entities in a manner that makes the type of CRM system/software used by the different businesses agnostic to the user. Thereafter, for each chat conversation the user has with a corresponding business entity, the centralized chat manager indexes the chat conversation and stores the indexed chat conversation in a conversation data store. Implementations further include the centralized chat manager executing a search interface (e.g., web-based application) that the user may access to input search criteria for locating relevant chat conversations stored in the conversation data store. Advantageously, the centralized chat manager uses the input search criteria to retrieve and return multiple chat conversations that are related to one another, despite the retrieved chat conversations corresponding to interactions the user had with different business entities. In some implementations, the chat interface and the search interface execute as extensions of a web browser or other web-based application.

In some implementations, the centralized chat manager annotates a chat conversation with relevant metadata (e.g., account numbers, order numbers, product purchase histories, dates, etc.) such that the user can obtain the relevant metadata when the chat conversation is returned in a search result to the user. The centralized chat manager may harvest the metadata from a variety of sources that may include, without limitation, a current chat conversation, one or more previous chat conversations associated with the user, and/or external sources (e.g., an email database, a calendar database, a text message database, etc.). Thus, implementations of the present disclosure allow a user to communicate with various business entities through a consistent interface from a single consolidated service (i.e., centralized chat manager) to provide the user with an enriched or supplemented history of the user's interactions with each entity.

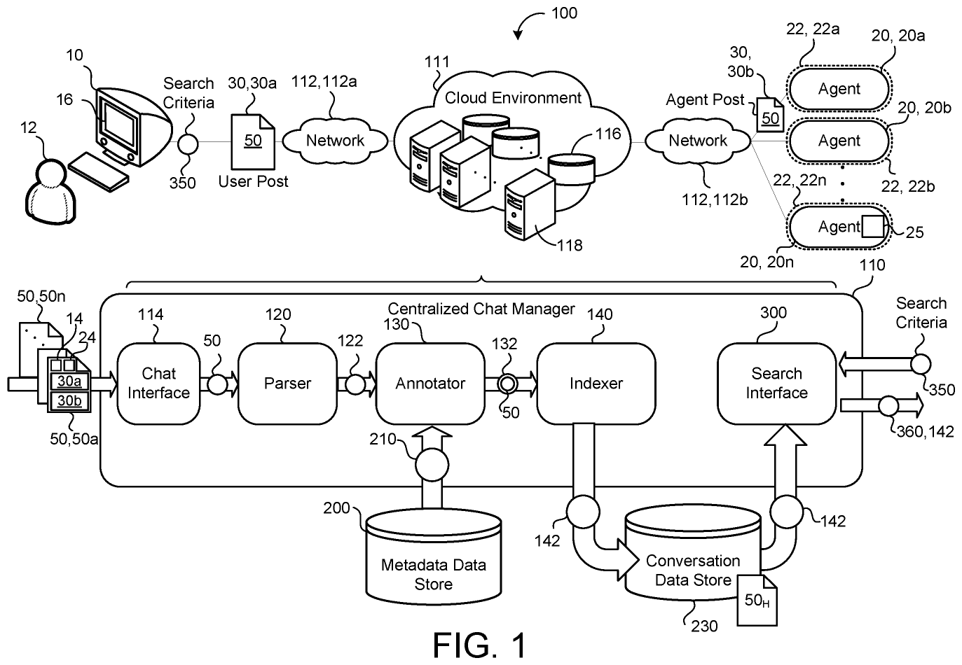

Referring to FIG. 1, in some implementations, an example system 100 includes a user device 10 associated with a respective user 12 and in communication with a remote system 111 via a network 112, 112a. The user device 10 may correspond to a computing device, such as a desktop workstation, laptop workstation, mobile device (e.g., smart phone or tablet), wearable device, smart appliance, smart display, or smart speaker. The remote system 111 may be a single computer, multiple computers, or a distributed system (e.g., a cloud environment) having scalable/elastic computing resources 118 (e.g., data processing hardware) and/or storage resources 116 (e.g., memory hardware). The remote system 111 is also in communication with one or more agents 20, 20a-n via a network 112b. The networks 112a, 112b may be the same network or different networks. Each agent 20 is associated with a respective entity 22, 22a-n and each entity 22 may be a unique entity that is different from the other entities 22. For example, each agent 20 may correspond to a customer support representative employed by the respective entity 22 and each entity 22 may correspond to a respective business. As used herein, the term “entity 22” may be interchangeably be referred to as “business entity 22”. In some examples, the user 12 is a customer of each business entity 22. For instance, entity 22a may correspond to a banking institution of the user 12, while entity 22b may correspond to a mortgage company of the user 12.

The data processing hardware 118 executes (i.e., using instructions stored on the storage resources) a centralized chat manager 110 (also referred to as ‘chat manager’) that receives a plurality of chat conversations 50, 50a-n associated with the particular user 12 and the plurality of different business entities 22, 22a-n. Here, the chat manager 110 executes a chat interface 114 that allows the user 12 to initiate a chat conversation 50 with an agent 20 supporting a particular business entity 22, whereby the chat conversation 50 corresponds to a stream/collection of posts 30 published/input by the user 10 and/or the agent 20. Each chat conversation 50 may include at least one of text data or voice data. In some examples, the chat interface 114 allows the user 12 and/or agents 20 to input posts 30 using speech. Here, the chat conversation 50 may include voice data associated with the posts 30 input by speech or the chat interface 114 may communicate with a speech recognition system that converts the speech into text. In some implementations, the chat interface 114 receives one or more chat posts 30 (or simply ‘posts’) in a respective chat conversation 50 as instant messaging text data communicated between the user 12 and the agent 20. As used herein, the term “posts” refer to comments, messages, notes, remarks, questions, and/or replies published by the user and/or the corresponding business entity 22 of the plurality of different business entities 22, 22a-n.

For a respective chat conversation 50, the posts 30 are arranged in chronological order. Thus, the stream of posts 30 in the chat conversation 50 may include user posts 30a published by the user 12 and agent posts 30b published by the agent 20 of the chat conversation 30. The chat conversation 50 between the user 12 and the respective agent 20 of the corresponding business entity 22 may include a stream/collection of posts 30 input via the chat interface 114 over a period of time. In some examples, the chat conversation 50 includes all posts 30 between the user 12 and the respective agent 20 such that only one chat conversation 30 exists between the user 12 and the respective agent 20. In other examples, after a chat conversation 30 is initiated, the chat conversation 30 persists after a threshold period of time has elapsed without receiving any more posts 30. In these examples, the chat manager 110 may receive and store multiple chat conversations 30 between the user and a same business entity 22, such that each chat conversation 30 includes a collection of posts 30 over a corresponding period of time between the user 12 and the respective agent 20 of the particular business entity 22 that is different than the periods of time corresponding to the other chat conversations. In some configurations, the chat interface 114 permits the user 12 to terminate/end a corresponding chat conversation 30 via a user input indication such as the user selecting a graphical button displayed (or speaking a designated command) through the chat interface 114.

The chat interface 114 executing on the chat manager 110 advantageously sits “between” the user 12 and each agent 20 to receive a chat post 30 from one of the user 12 or the agent 20 and, after logging the post 30, relays the post 30 on to the other one of the user 12 or the agent 20. In some examples, the chat interface 114 receives one or more posts 30 from a third party that is other than the user 12 or the agent 20 of the business entity 22. When the chat interface 114 receives the posts 30, i.e., user posts 30a and/or agent posts 30b, the chat interface 114 may provide a consistent interface to the user 12 that shows the collection of posts 30 for the corresponding chat conversation 50 independent of an interface or software the agent 20 uses to facilitate the chat conversation 50 with the user 12. For example, while a business entity 22 may employ a different type of customer relationship management (CRM) system 24 and associated agent-side interface for facilitating chat conversations 50 between the respective agent 20 and the user 12 through the chat manager 110, the chat interface 114 may consistently display each post 30 (and/or output audio) published by the user 12 and/or the agent 20 chronologically or in some other order specified by the user 12. In other words, the chat interface 114 provides the user 12 with a consistent user interface 114 that is configurable and compatible with a multitude of different types of CRM systems 24, thereby providing an entity- and agent-agnostic chat interface. A CRM system 24 and associated software provides a business entity 22 with a wide variety of applications that help manage, among other things, customer data, customer interactions, and customer support. There are several CRM offerings for a business to choose from, and different CRMs offer different customer interaction support solutions (i.e., chat interfaces). Thus, the chat manager 110 is configured to communicate with a wide number of different CRM solutions and translate the communication to provide a consistent offering to the user 12 that is agnostic of any specific CRM solution. For example, the chat interface 114 may permit the user device 10 associated with the user 12 to integrate with a particular CRM solution via a website, mobile application, social media platform, email, etc. The centralized chat manager 110 may store relevant details pertaining to specific CRM solutions in the storage resources 116, and recall these details when a chat conversation is initiated between the user 12 and a corresponding business entity 22. Thus, the chat interface 114 executing on the data processing hardware 118 is configured to pass chat posts 30, for each chat conversation 50 of the plurality of chat conversations 50, between the user 12 and the corresponding CRM system associated with the corresponding business entity 22 of the plurality of different business entities 22.

With continued reference to FIG. 1, the chat manager 110 further includes a parser 120, an annotator 130, and an indexer 140. For each chat conversation 50 between the user and a respective agent 20 of a corresponding business entity 22, the parser 120 parses the chat conversation 50 for any keywords 122, and for each parsed keyword 122, the annotator 130 harvests metadata 210 relevant to the parsed keyword 122 and annotates the chat conversation 50 with the harvested metadata 210. In some examples, the parser 120 analyzes each word, sub-word, or groups of words in the received chat conversation 50 to find any predetermined keywords 122. When a predetermined keyword 122 is found, the parser 120 parses the keyword 122 from the chat conversation 50 and passes the parsed keyword 122 to the annotator 130.

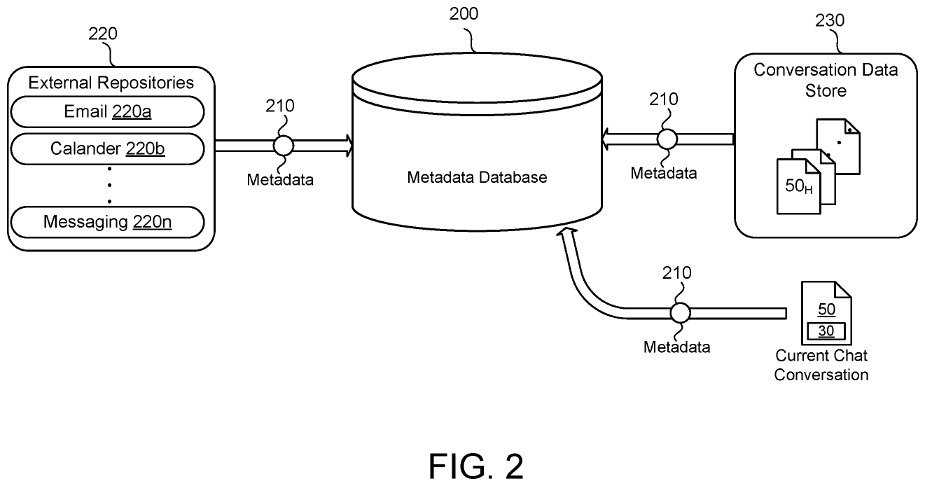

In the example shown, the annotator 130 is in communication with a metadata data store 200 that stores various metadata 210 that may be useful for annotating chat conversations 50 based on the keywords 122 parsed therefrom. The metadata data store 200 may reside on the storage resources 118 (e.g., memory hardware) of the remote system 111, on the user device 10, a third-party storage resource, or some combination thereof. The chat manager 110 may harvest metadata 210 for parsed keywords 122 from multiple sources, some of which may be external to the chat manager 110, and store the metadata 210 within the metadata data store 200. Referring to FIG. 2, the chat manager 110 may harvest/obtain the metadata 210 from a source that is different than a source of the corresponding chat conversation 50. For instance, the chat manager 110 may harvest metadata 210 from one or more external sources (e.g., external repositories) 220, 220a-n containing metadata 210 specific to the user 10 such as an email repository 220a associated with the user 12, a calendar repository 220b associated with the user 12, and/or a messaging repository 220n associated with the user 12. For example, when the user 12 places an order for a product from one of the business entities 22, the business entity 22 may send a confirmation email or message to the user 12 with various relevant metadata 310 (e.g., account number, order number, data, price, etc.). The chat manager 110 may access the email or message repository 220a, 220n where this information is stored and copy the information as metadata 310 into the metadata data store 200. This list of external repositories 220 is non-exhaustive and may include additional external repositories that may provide metadata 210 for enriching chat conversations 50.

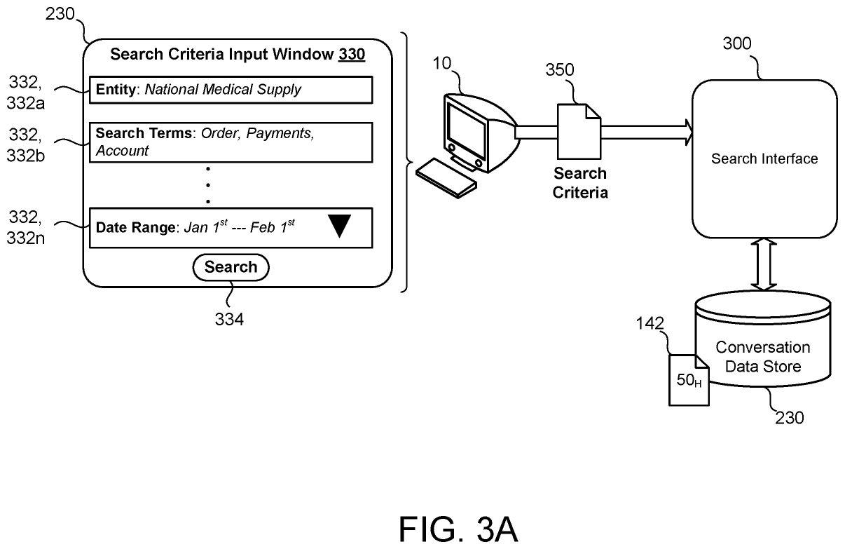

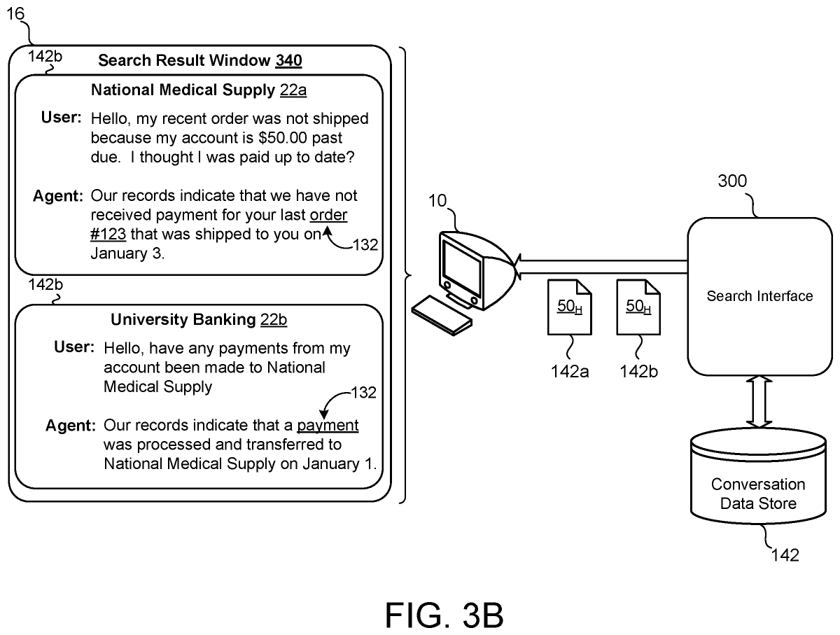

Additionally or alternatively, the chat manager 110 may harvest metadata 210 from the current chat conversation 50 or one or more historic chat conversations 50_{H} associated with the user 12 and stored in a conversation data store 230. For example, the user 12 may discuss an account number in a post 30 of a chat conversation 50 with an agent 20 of a business entity 22 that includes a banking institution. Here, the chat manager 110 (e.g., when parsing the corresponding post 30 at the parser 120) may store the account number in the metadata data store 200 along with any other relevant identifying information, such as a user identifier 14 (FIG. 1) identifying the user 12 and/or an agent identifier 24 (FIG. 1) identifying the agent 20. Described in greater detail below with reference to FIGS. 1 and 3, the conversation data store 230 is configured to store indexed, annotated chat conversations 50 that the user may search via a search interface 300 executing on the chat manager 110. Additionally, the chat manager 110 may harvest metadata 210 from one or more posts 30 of the current chat conversation 50 prior to storing the current chat conversation 50 in the conversation data store 230 since the current chat conversation 50 has not yet been annotated or indexed.

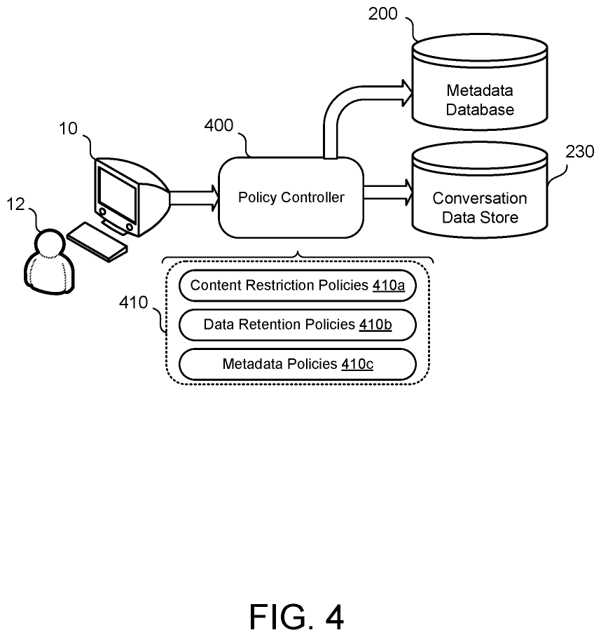

The chat manager 110 may harvest some metadata 210 in real-time. For example, the chat manager 110 may harvest metadata 210 from the chat conversation 50, or one or more posts 30 associated with the chat conversation 50, as the chat interface 114 receives the chat conversation 50. In some implementations, the chat manager 110 harvests some types/categories of metadata 210 at scheduled times (e.g., once an hour, once a day, etc.). For example, metadata 210 obtained from one or more of the external repositories 220 may be harvested once a day (e.g., a batch metadata harvest). In some examples, the user 12 configures a frequency of harvesting for some types/categories of metadata 210 using a policy controller (FIG. 4).

Referring back to FIG. 1, the annotator 130 receives each parsed keyword 122 and, if available, annotates the keyword 122 with relevant metadata 210 from the metadata data store 200. For example, the annotator 130 may annotate the keyword “order” with the relevant order number and annotate the keyword “account” with the relevant account number. In this example, the metadata 210 include tags identifying the user 12 and/or the business entity 22 associated with the metadata 210. For instance, the relevant order number may be harvested from an “Order Confirmation” email within the user's 12 email repository 220a that was sent from the corresponding business entity 22 associated with the chat conversation 50 being annotated. Likewise, the relevant account number may be harvested from a chat conversation 50, 50_{H} in which the user 12 published the account number in a post 30.

After annotating the chat conversation 50 with the metadata 210, the annotations are visible to the user 12 as annotated data 132 when the user 12 views the chat history, e.g., as a historic chat conversation 50_{H}. In some scenarios, the annotated data 132 includes, for each parsed keyword 122, a corresponding keyword-metadata pair that includes the parsed keyword 122 and harvested metadata 210 relevant to the keyword 122. In other scenarios, the annotated data 132 includes a list of the harvested metadata 210 relevant to all of the keywords 122 parsed from the chat conversation 50. Additional scenarios may include a portion of the annotated data 132 including keyword-metadata pairs generated for certain types of keywords 122 parsed from the chat conversation 50 while a remaining portion of the annotated data 132 simply includes the listing of harvested metadata 210 that is relevant to other types of keywords 122 parsed from the chat conversation 50. In any of these scenarios, the annotator 130 appends/attaches the annotated data 132 to the chat conversation 50 (or a corresponding post 30 of the chat conversation 50) to enrich or supplement the chat conversation between the user 12 and the respective agent 20 of the corresponding business entity 22. In this way, the user 12 may readily attain pertinent information from the annotated data 132 when the user 12 reviews the chat conversation 50 at a later time as a historic chat conversation 50_{H} (i.e., the chat history). As used herein, the annotated data 132 appended to the chat conversation 50 may collectively be referred to as an “annotated chat conversation”.

Still referring to FIG. 1, the annotator provides the annotated chat conversation (i.e., the annotated data 132 appended to the corresponding chat conversation 50) to the indexer 140 and the indexer 140 indexes the annotated chat conversation by parsing the annotated data 132 from the chat conversation 50 for storage as an indexed, annotated chat conversation 142 in the conversation data store 50. The conversation data store 230 may reside on the storage resources (e.g., memory hardware) 118 of the remote system 111. The indexer 140 may use any appropriate index data structures (e.g., suffix trees, inverted indexes, etc.) to index the annotated data 132. In some examples, the indexer 140 indexes the parsed chat conversation 50 (or one or more associated posts 30) output from the parser 120 before the annotator 130 annotates the chat conversation 50 with the relevant metadata 210. In these examples, the indexer 140 applies the annotated data 132 to the indexes of the parsed chat conversation 50 to provide annotated indexes. Additionally, the annotator 130 update the annotated data 132 by harvesting new or updated metadata 210 at a later time. In this scenario, the indexer 140 may apply the updated annotated data 132 to a historic chat conversation 50_{H} previously stored in the chat conversation data store 230.

The conversation data store 50 may contain a plurality of historic chat conversations 50_{H} between the user 12 and different business entities 22. Each historic chat conversation 50_{H} may correspond to an indexed, annotated chat conversation 142. Each indexed, annotated chat conversation 142 output from the indexer 140 for storage in the conversation data store 230 facilitates fast and accurate retrieval of one or more historic chat conversations 50_{H} in response to search criteria 350 input by the user 12. The input search criteria 350 may correspond to a query from the user includes one or more keywords are parameters for locating one or more of the indexed, annotated chat conversations 142 that include annotated data 132 (i.e., metadata 210) that satisfies (e.g., matches) the keywords or parameters of the input search criteria 350.

The metadata data store 200 may store metadata 210 for an entire user population and only provide metadata 210 for a particular user 12 when the particular user 12 is authorized and authenticated by the chat manager 110. Similarly, the chat conversation data store 230 may maintain a repository of historic chat conversations 50_{H} for a user population and only provide metadata 210 from a historic chat conversation 50_{H} associated with a particular user 12 when the particular user 12 is authorized and authenticated by the chat manager 110. Accordingly, each chat conversation 50 (or post 30) received through the chat interface 114 may include a user token 14 identifying the user 12 and providing user credentials indicating that the user 12 is authenticated and authorized. One or more chat conversations 50 (or post) may optionally include an entity identifier 24 identifying the corresponding business entity 22.

The centralized chat system 110 further executes a search interface 300 configured to receive search criteria 350 from the user device 10 input by the user 12 and provide a search result 360 back to the user device 10 that includes one or more indexed, annotated chat conversations 142 retrieved from the conversation data store 230. Specifically, the user device 10 may send a query, including the search criteria 350 input by the user 122, to the search interface 300 and the search interface 300 may retrieve one or more indexed-annotated chat conversations 142 that satisfy the search criteria 350 from the conversation data store 230. The search interface 300 may then send the search result 360 including the retrieved one or more indexed, annotated chat conversations 142 back to the user device 10.

Referring to FIGS. 3A and 3B, in some implementations, the user device 10 communicates through the search interface 300 by accessing a webpage or via a dedicated software application executing on the user device 10. For instance, the webpage or dedicated software application may correspond to a web browser having a search engine. In the example shown, the user device 10 executes a graphical user interface 16 for display on the user device 10 to input the search criteria 350 in a search criteria input window 330 (FIG. 3A) and view search results 360 returned from the search interface 300 displayed in a search result window 340 (FIG. 3B). Referring to FIG. 3A, the search criteria input window 330 may include one or more fields 332, 332a-n for inputting keywords and/or parameters to locate any historic chat conversations 50_{H} relevant to the input search criteria the user 10 wants to view (and/or hear audible outputs of the historic chat conversations). For instance, an entity field 332a may permit the user 12 to input (e.g., by typing) a name of a business entity 22 (e.g., National Medical Supply), a search terms field 332b may permit the user 12 to input one or more keywords (e.g., Order, Payments, Account), and a date range field 332n may permit the user to input a date range. In the example shown, the user 12 may select the date range via a drop down that may include calendars for inputting a start date and/or an end date. In the example shown, the user 10 would like the search interface 300 to retrieve historic chat conversations 50H (i.e., indexed, annotated chat conversations 142) pertaining to National Medical supply from January 1^{st} through February 1^{st} and including the keywords Order, Payments, and Account. The graphical user interface 16 may include a search button 334, that when selected by the user 10, causes the user device 10 to transmit the information input into the search criteria input window 330 as search criteria 350 to the search interface 300.

Referring to FIG. 3B, after the search interface 300 receives the search criteria 350 from the user device 10, the search interface 300 retrieves one or more of the indexed, annotated chat conversations 142 that satisfy the received search criteria 350 from the conversation data store 230, and transmits a search result 360 to the user device 10. Here, the search result 360 received by the user device 12 includes the one or more indexed, annotated chat conversations 142 retrieved from the conversation data store 230. Continuing with the example provided by FIG. 3A, the search interface 300 retrieves and transmits two indexed, annotated chat conversations 142a, 142b that satisfy the received search criteria 350 input to the search criteria input window 330b of FIG. 3A. In this example, FIG. 3B shows the graphical user interface 16 displaying, in the search result window 340, the first indexed, annotated chat conversation 142a and the second indexed, annotated chat conversation 142b simultaneously. The first indexed, annotated chat conversation 142a is associated with a historic chat conversation 50_{H} between the user 12 and a respective agent 20 of an entity 22a named “National Medical Supply”, and the second indexed, annotated chat conversation 142b is associated with the user 12 and a respective agent 20 of an entity 22b named “University Banking”. Here, the first indexed, annotated chat conversation 142a includes the named entity 22a input in the entity field 332a of FIG. 3A and relates to one or more of the search terms input to the search terms field 332b of FIG. 3A. Specifically, the annotated conversation 142a corresponds to a user post inquiring about a possible erroneous past due charge from a medical supply business entity 22a (e.g., National Medical Supply), and a responsible agent post indicating that no payment was received for a previous order shipped on a specific date (e.g., January 3). The agent post includes annotated data 132 associated with the keyword “order #123” depicted as underlined, such that the additional metadata 210 relevant to the keyword “order #123” may be presented to the user 12 to enrich the chat conversation 142a. For example, the user 12 may select or hover a cursor over the annotated data 132 to cause the graphical user interface 16 to present the additional metadata 210 as a pop-up window or in some other way that is convenient for the user 12 to view. In the example shown, a pop-up window associated with the annotated data 132 for the keyword “order #123” may include a name of the product, cost of the product, shipping date, user account information, and any other pertinent information associated with the keyword “order #123”.

The second indexed, annotated chat conversation 142b corresponds to a related user post inquiring about any previous payments made to a named entity (e.g., National Medical Supply). Since, the user 12 is concerned with any payments made or not made around January 3 (e.g., the date “order #123” was shipped), the input search criteria 350 inputs a date range of January 1^{st} through February 1^{st} to only include relevant historic chat conversations within this date range, while filtering out others. The agent post includes annotated data 132 associated with the keyword “payment” depicted as underlined, such that the additional metadata 210 relevant to the keyword “payment” may be presented to the user 12 to enrich the chat conversation 142b. For example, the user 12 may select or hover a cursor over the annotated data 132 to cause the graphical user interface 16 to present the additional metadata 210 as a pop-up window or in some other way that is convenient for the user 12 to view. In the example shown, a pop-up window associated with the annotated data 132 for the keyword “payment” may include a user's account number, a transaction showing payment in the amount of $50.00 from University Banking to National Medical Supply on January 1, and any other pertinent information associated with the keyword. While each of the indexed, annotated chat conversations 142a, 142b displayed in the search result window 340 only include annotated data 132 for one keyword, the chat conversations 142a, 142b may include annotated data 132 for harvested metadata 210 relevant to multiple keywords 122 in other examples.

In some implementations, the graphical user interface 16 displays one or more indexed, annotated chat conversations 142 in the search result window 340 while concurrently displaying a current chat conversation 50 between the user 12 and a business entity 22 to allow the user 12 search for, and view, previous chat conversations 50H that may be relevant to the current chat conversation 50. In some implementations, the chat manager 110 provides the chat interface 114 and the search interface 200 through the same interface accessible through the graphical user interface 16 executing on the user device 10. For instance, the chat interface 114 and the search interface 200 may be accessed via a webpage for a corresponding web browser and search engine, a web-based application, or software application executing on the user device 10.

Referring now to FIG. 4, in some implementations, the chat manager 110 executes a policy controller 400. The policy controller 400 may enforce one or more user policies 410 that may include, without limitation, content restriction policies 410a, data retention policies 410b, and metadata policies 410c. The content restriction policies 410a may control what types of chat conversations 50 are stored, and may further specify chat conversations associated with specific agents 20 and/or entities 22 the user 10 wants to persist for storage (or not store). The data retention policies 410b may indicate a storage duration threshold or capacity threshold for chat conversations 50 stored in the conversation data store 230. For instance, a data retention policy 410b may delete all chat conversations 50 stored for longer than the storage duration threshold (e.g., six months). The metadata policies 410c may specify, for example, the sources (e.g., external repositories 220, conversation data store 230, current chat conversation 50) the chat manager 110 may harvest metadata 310 from, the frequency that metadata 310 is harvested, and the types of metadata 310 harvested. Each policy 410 may be user configurable. That is, the user 12, via the user device 10, may alter or update each policy 410 and, in some examples, directly edit or delete metadata 210 stored in the metadata data store 200 and/or historic chat conversations 50_{H} stored in the conversation data store 230. For example, when a user closes an account with a particular business entity 22, the user 12 may delete all metadata 210 and/or chat conversations 50 associated with that entity 22. The policy controller 400 may follow automatic rules or defaults. For example, if a user 12 has not explicitly consented to the storage of specific data (e.g., indexed chat conversations 142 associated with a particular entity 22), the policy controller 400 may enforce deletion of these indexed chat conversations 142, and any associated metadata 210, within a specified time period (e.g., 30-days).

Additionally, the chat manager 110 may provide a user with controls that allow the user to elect if and when systems, programs, or features described herein may enable collection of user information (e.g., information about a user's social network, social actions or activities, profession, a user's preferences, or a user's current location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

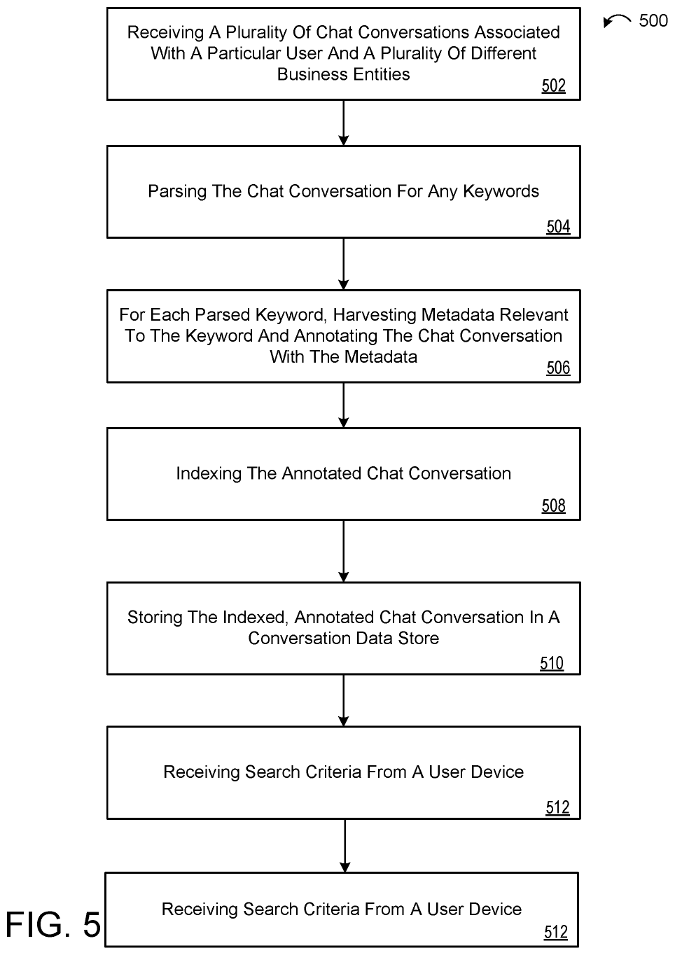

FIG. 5 is a flowchart of an example method 500 for providing historical chat conversations to a user 12. The method 500 may be described with reference to FIGS. 1-4. The method 500 starts at operation 502 by receiving, at data processing hardware 118, a plurality of chat conversations 50 associated with a particular user 12 and a plurality of different business entities 22. Each chat conversation 50 of the plurality of chat conversations 50 is between the user and a corresponding business entity 22 of the plurality of different business entities 22. At operation 504, for each chat conversation 50 of the plurality of chat conversations 50, the method 500 includes parsing, by the data processing hardware 118, the chat conversation 50 for any keywords 122, and at operation 506, for each parsed keyword 122, the method 500 includes harvesting, by the data processing hardware 118, metadata 210 relevant to the keyword 122 and annotating, by the data processing hardware 118, the chat conversation 50 with the metadata 210. For each chat conversation 50 of the plurality of chat conversations 50, the method 500 also includes, at operation 508, indexing, by the data processing hardware, the annotated chat conversation, and at operation 510, storing, by the data processing hardware 118, the indexed, annotated chat conversation 142 in a conversation data store 230 in communication with the data processing hardware 118. At operation 512, the method 500 also includes receiving, at the data processing hardware 118, search criteria 350 from a user device 10 associated with the user 10 and retrieving one or more of the indexed, annotated chat conversations 142 that satisfy the received search criteria from the conversation data store 230. At operation 514, the method 500 also includes, transmitting, by the data processing hardware 118, a search result 360 to the user device 10. The search result 360 includes the one or more indexed, annotated chat conversations 142 retrieved from the conversation data store 230.

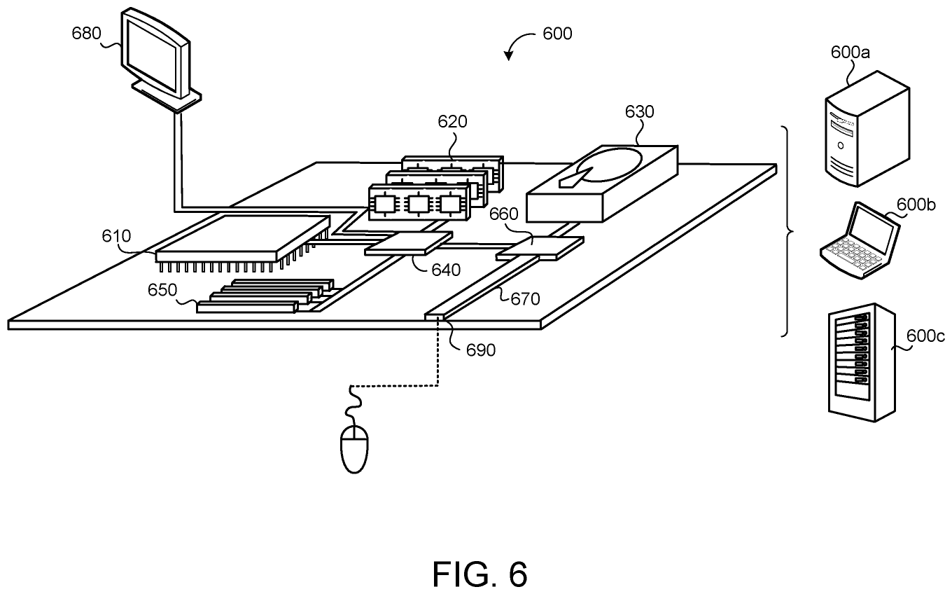

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, at data processing hardware, a plurality of chat conversations associated with a particular user and a plurality of different business entities, each chat conversation of the plurality of chat conversations between the user and a corresponding business entity of the plurality of different business entities;
for each chat conversation of the plurality of chat conversations:
parsing, by the data processing hardware, the chat conversation for any keywords;
for each parsed keyword, harvesting, by the data processing hardware, metadata relevant to the keyword;
annotating, by the data processing hardware, the chat conversation with the metadata;
indexing, by the data processing hardware, the annotated chat conversation; and
storing, by the data processing hardware, the indexed, annotated chat conversation in a conversation data store in communication with the data processing hardware;
receiving, at the data processing hardware, search criteria from a user device associated with the user;
retrieving, by the data processing hardware, one or more of the indexed, annotated chat conversations that satisfy the received search criteria from the conversation data store; and
transmitting, by the data processing hardware, a search result to the user device, the search result comprising the one or more indexed, annotated chat conversations retrieved from the conversation data store.

2. The method of claim 1, wherein each chat conversation of the plurality of chat conversations comprises at least one of text data or voice data.

3. The method of claim 1, wherein harvesting the metadata relevant to the keyword comprises obtaining the metadata from a source that is different than a source of the corresponding chat conversation.

4. The method of claim 3, wherein the source of the metadata comprises at least one of an email repository associated with the user, a calendar repository associated with the user, or a messaging repository associated with the user.

5. The method of claim 1, wherein harvesting the metadata relevant to the keyword comprises obtaining the metadata from at least one of a current chat conversation or one or more previous chat conversations associated with the user.

6. The method of claim 1, further comprising executing, by the data processing hardware, a chat interface configured to pass chat posts, for each chat conversation of the plurality of chat conversations, between the user and a corresponding customer relationship management (CRM) system associated with the corresponding business entity of the plurality of different business entities.

7. The method of claim 6, wherein the corresponding CRM systems associated with at least two of the plurality of different business entities are different.

8. The method of claim 6, wherein the chat posts comprise at least one of comments, messages, notes, remarks, questions, or replies published by the user and/or a respective agent of the corresponding business entity of the plurality of different business entities.

9. The method of claim 1, wherein indexing the annotated chat conversation comprises indexing the annotated chat conversation based upon the corresponding business entity of the plurality of business entities.

10. The method of claim 1, wherein the search result, when received by the user device, causes the user device to display the one or more indexed, annotated chat conversations retrieved from the conversation data store on a graphical user interface executing on the user device.

11. A system comprising:
data processing hardware; and
memory hardware in communication with the data processing hardware, the memory hardware storing instructions that when executed on the data processing hardware cause the data processing hardware to perform operations comprising:
receiving a plurality of chat conversations associated with a particular user and a plurality of different business entities, each chat conversation of the plurality of chat conversations between the user and a corresponding business entity of the plurality of different business entities;
for each chat conversation of the plurality of chat conversations:
parsing the chat conversation for any keywords;
for each parsed keyword, harvesting metadata relevant to the keyword;
annotating the chat conversation with the metadata;
indexing the annotated chat conversation; and
storing the indexed, annotated chat conversation in a conversation data store in communication with the data processing hardware;
receiving search criteria from a user device associated with the user;
retrieving one or more of the indexed, annotated chat conversations that satisfy the received search criteria from the conversation data store; and
transmitting a search result to the user device, the search result comprising the one or more indexed, annotated chat conversations retrieved from the conversation data store.

12. The system of claim 11, wherein each chat conversation of the plurality of chat conversations comprises at least one of text data or voice data.

13. The system of claim 11, wherein harvesting the metadata relevant to the keyword comprises obtaining the metadata from a source that is different than a source of the corresponding chat conversation.

14. The system of claim 13, wherein the source of the metadata comprises at least one of an email repository associated with the user, a calendar repository associated with the user, or a messaging repository associated with the user.

15. The system of claim 11, wherein harvesting the metadata relevant to the keyword comprises obtaining the metadata from at least one of a current chat conversation or one or more previous chat conversations associated with the user.

16. The system of claim 11, wherein the operations further comprise executing a chat interface configured to pass chat posts, for each chat conversation of the plurality of chat conversations, between the user and a corresponding customer relationship management (CRM) system associated with the corresponding business entity of the plurality of different business entities.

17. The system of claim 16, wherein the corresponding CRM systems associated with at least two of the plurality of different business entities are different.

18. The system of claim 16, wherein the chat posts comprise at least one of comments, messages, notes, remarks, questions, or replies published by the user and/or a respective agent of the corresponding business entity of the plurality of different business entities.

19. The system of claim 11, wherein indexing the annotated chat conversation comprises indexing the annotated chat conversation based upon the corresponding business entity of the plurality of business entities.

20. The system of claim 11, wherein the search result, when received by the user device, causes the user device to display the one or more indexed, annotated chat conversations retrieved from the conversation data store on a graphical user interface executing on the user device.
